(19) United States
(12) Patent Application Publication
(10) Pub. No.: US 2009/0076837 A1
(43) Pub. Date: Mar. 19, 2009

(54) SYSTEM AND METHOD FOR PRODUCT DEFINITION

(76) Inventor: WAYNE COLLIER, NEW YORK, NY (US)

Correspondence Address: Siemens Corporation;Intellectual Property Department, 170 Wood Avenue South, Iselin, NJ, 08830, US

(21) Appl. No.: 12/210,166

(22) Filed: Sep. 12, 2008

Related U.S. Application Data
(60) Provisional application No. 60/972,016, filed on Sep. 13, 2007.

(51) Int. Cl. G06Q 10/00; G06F 19/00

(52) U.S. Cl. 705/1; 700/97

(57) ABSTRACT

A system, method, and computer program for defining products, comprising creating a platform definition; reusing the platform definition in a plurality of product configurations; and delivering the plurality of product configurations to at least one program; whereby the platform definition is not modified and appropriate means and computer-readable instructions.

### TECHNICAL FIELD

The system of the innovations described herein relate generally to software applications. More specifically, the system relates to digital product management.

### BACKGROUND

Computer aided design (CAD) and/or visualization applications use product data management systems for configuring products. Bill of materials (BOMs) are utilized to help define configured products. There are various views of BOMs depending upon what sort of information is sought, e.g., process and materials.

### SUMMARY

To achieve the foregoing, and in accordance with the purpose of the presently preferred embodiment as broadly described herein, the present application provides a method for defining products, comprising creating a platform definition; reusing the platform definition in a plurality of product configurations; and delivering the plurality of product configurations to at least one program; whereby the platform definition is not modified. The method, wherein the platform definition is a vehicle platform. The method, wherein the at least one program is a business investment cycle.

Another advantage of the presently preferred embodiment is to provide a platform definition, comprising a defined list of elements; a vehicle platform of the defined list of elements; a plurality of product configurations that can reuse the vehicle platform; a plurality of programs defined by the plurality of product configurations where the platform definition is not modified. The platform definition, wherein the plurality of programs are business investment cycles.

And another advantage of the presently preferred embodiment is to provide a system for platform definition, comprising a computer system, wherein the computer system includes a memory, a processor, a user input device, and a display device; a computer displayed hierarchical list for a product structure; and wherein a user uses the computer system and the computer system creates a platform definition; reuses the platform definition in a plurality of product configurations; and delivers the plurality of product configurations to at least one program; whereby the platform definition is not modified. The system, wherein the platform definition is a vehicle platform.

Yet Another advantage of the presently preferred embodiment is to provide a data processing system having at least a processor and accessible memory to implement a method for defining a platform, comprising: means for creating a platform definition; means for reusing the platform definition in a plurality of product configurations; and means for delivering the plurality of product configurations to at least one program.

Other advantages of the presently preferred embodiment will be set forth in part in the description and in the drawings that follow, and, in part will be learned by practice of the presently preferred embodiment. The presently preferred embodiment will now be described with reference made to the following Figures that form a part hereof. It is understood that other embodiments may be utilized and changes may be made without departing from the scope of the presently preferred embodiment.

### BRIEF DESCRIPTION OF THE DRAWINGS

A presently preferred embodiment will hereinafter be described in conjunction with the appended drawings, wherein like designations denote like elements, and:

FIG. 1 is a logic flow diagram of the method employed by the presently preferred embodiment;

FIGS. 2a-2b generally illustrate platform engineering and early bill of material (BOM) processes;

FIG. 3 illustrates a select view for a platform-common partition;

FIG. 4 illustrates a generic components view for platform-common partitions;

FIGS. 5a-5c illustrate views for defining physical architecture; and

FIG. 6 is a block diagram of a computer environment in which the presently preferred embodiment may be practiced.

### DETAILED DESCRIPTION OF THE PREFERRED EMBODIMENTS

### 1. Computer System

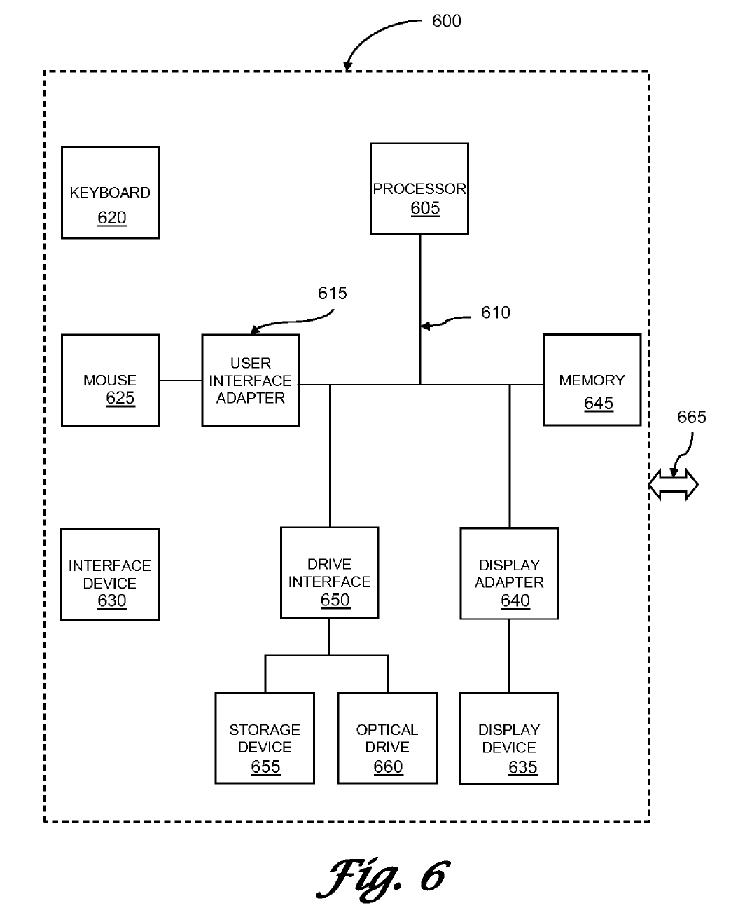

The numerous innovative teachings of the present application will be described with particular reference to the presently preferred embodiments. It should be understood, however, that this class of embodiments provides a few examples of the many advantageous uses of the innovative teachings herein. The presently preferred embodiment provides, among other things, a system and method for defining products. Now therefore, in accordance with the presently preferred embodiment, an operating system executes on a computer, such as a general-purpose personal computer. FIG. 6 and the following discussion are intended to provide a brief, general description of a suitable computing environment in which the presently preferred embodiment may be implemented. Although not required, the presently preferred embodiment will be described in the general context of computer-executable instructions, such as program modules, being executed by a personal computer. Generally program modules include routines, programs, objects, components, data structures, etc., that perform particular tasks or implementation particular abstract data types. The presently preferred embodiment may be performed in any of a variety of known computing environments.

Referring to FIG. 6, an exemplary system for implementing the presently preferred embodiment includes a general-purpose computing device in the form of a computer 600, such as a desktop or laptop computer, including a plurality of related peripheral devices (not depicted). The computer 600 includes a microprocessor 605 and a bus 610 employed to connect and enable communication between the microprocessor 605 and a plurality of components of the computer 600 in accordance with known techniques. The bus 610 may be any of several types of bus structures including a memory bus or memory controller, a peripheral bus, and a local bus using any of a variety of bus architectures. The computer 600 typically includes a user interface adapter 615, which connects the microprocessor 605 via the bus 610 to one or more interface devices, such as a keyboard 620, mouse 625, and/or other interface devices 630, which can be any user interface device, such as a touch sensitive screen, digitized pen entry pad, etc. The bus 610 also connects a display device 635, such as an LCD screen or monitor, to the microprocessor 605 via a display adapter 640. The bus 610 also connects the microprocessor 605 to a memory 645, which can include ROM, RAM, etc.

The computer 600 further includes a drive interface 650 that couples at least one storage device 655 and/or at least one optical drive 660 to the bus. The storage device 655 can include a hard disk drive, not shown, for reading and writing to a disk, a magnetic disk drive, not shown, for reading from or writing to a removable magnetic disk drive. Likewise the optical drive 660 can include an optical disk drive, not shown, for reading from or writing to a removable optical disk such as a CD ROM or other optical media. The aforementioned drives and associated computer-readable media provide non-volatile storage of computer readable instructions, data structures, program modules, and other data for the computer 600.

The computer 600 can communicate via a communications channel 665 with other computers or networks of computers. The computer 600 may be associated with such other computers in a local area network (LAN) or a wide area network (WAN), or it can be a client in a client/server arrangement with another computer, etc. Furthermore, the presently preferred embodiment may also be practiced in distributed computing environments where tasks are performed by remote processing devices that are linked through a communications network. In a distributed computing environment, program modules may be located in both local and remote memory storage devices. All of these configurations, as well as the appropriate communications hardware and software, are known in the art.

Software programming code that embodies the presently preferred embodiment is typically stored in the memory 645 of the computer 600. In the client/server arrangement, such software programming code may be stored with memory associated with a server. The software programming code may also be embodied on any of a variety of non-volatile data storage device, such as a hard-drive, a diskette or a CD-ROM. The code may be distributed on such media, or may be distributed to users from the memory of one computer system over a network of some type to other computer systems for use by users of such other systems. The techniques and methods for embodying software program code on physical media and/or distributing software code via networks are well known and will not be further discussed herein.

### 2. Product Definition Method

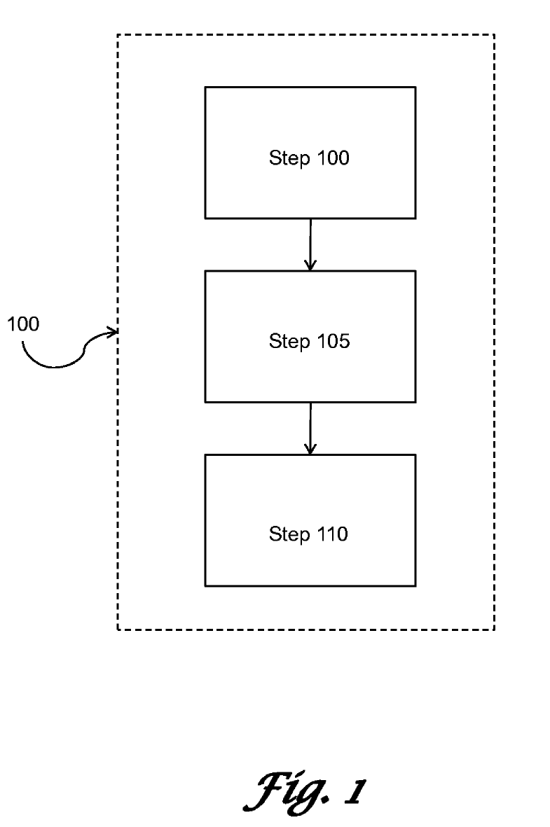

FIG. 1 is a logic flow diagram of the method employed by the presently preferred embodiment. Referring to FIG. 1, the presently preferred embodiment discloses a method 100 for defining products that creates a platform definition at Step 100. The method next reuses the platform definition in a plurality of product configurations at Step 105. The method next delivers the plurality of product configurations to at least one program at Step 110 so that the platform definition is not modified.

### 3. Product Definition Steps

One or more positioned CAD (computer aided design) occurrences and their related items may be aligned to a single solution in early phases. This differs from normal CAD-BOM alignment because the CAD associated to a single solution may represent many different parts in the produce. That is there can be a list or set of CAD occurrences for the same solution. Also, there is no distinction at this phase between a CAD solution and a part solution. Further, CAD occurrences still appear as sub-usages, but most typical validation of CAD-BOM alignment would apply.

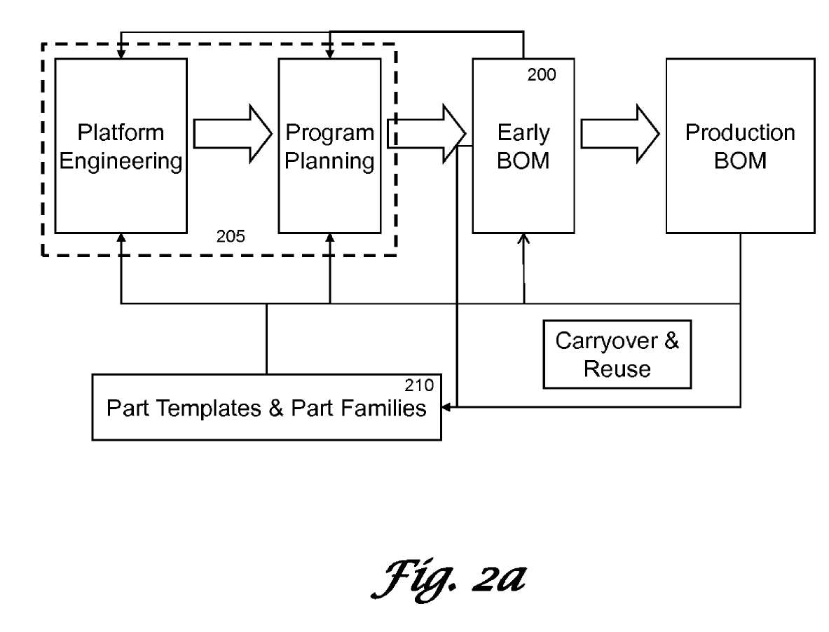

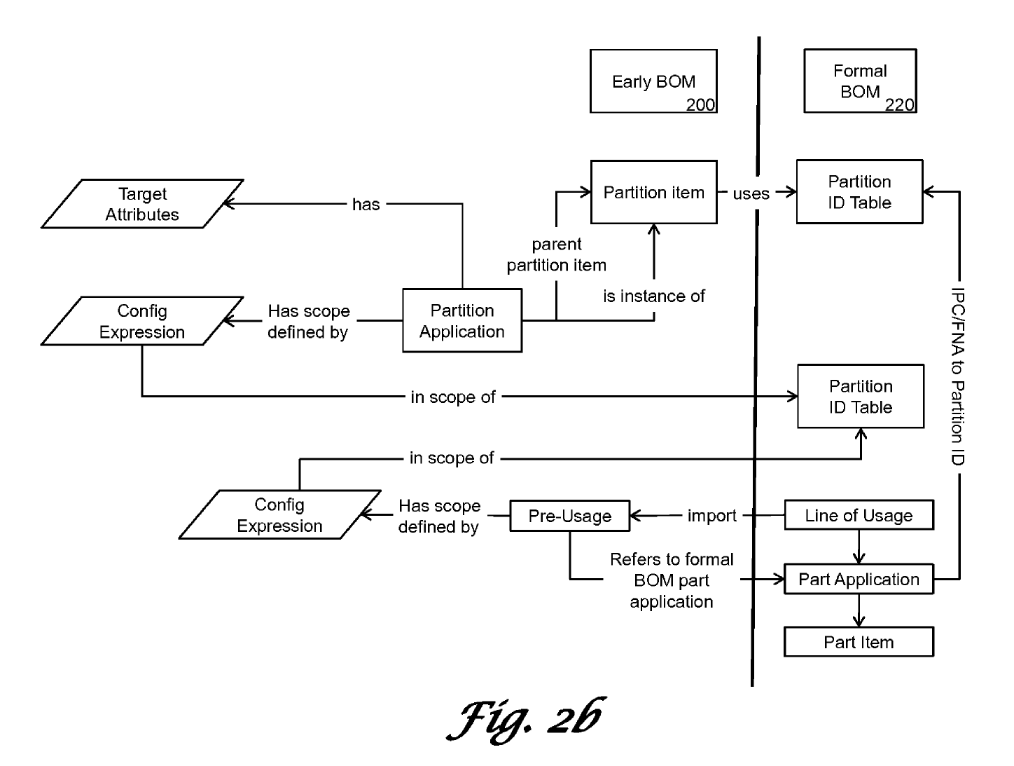

FIGS. 2a-2b generally illustrate platform engineering and early bill of material (BOM) processes. Referring further to FIG. 2a, early bill of material (BOM) 200 starts with solution variants for each partition, where partitions include links to database-managed documents illustrating manufacturing processes, quality, process variation and valid uses for all parts organized around base parts. Preferably, the parts derive their partition definitions from a standard library. Early BOM 200 then defines base parts required to fulfill each solution variant. Following commonality guidelines in program & platform architecture 205, new or carryover parts may be added at 210. Part number assignment may be delayed until after integrated release BOM is defined and manufacturing process is known. Program architecture describes the set of partitions in a program, including those that will be common across products in the program, and which will be unique. This forms the basis for the Production (or Planning) BOM 215. Platform architecture defines a set of partitions that remain stable across programs and products. Platform architecture links to program architecture through the set of platform-common partitions. FIG. 2b is a more detailed illustration of the concepts discussion with regard to FIG. 2a, where Formal BOM 220 is the same as Production BOM.

a. Platform-Common Partitions

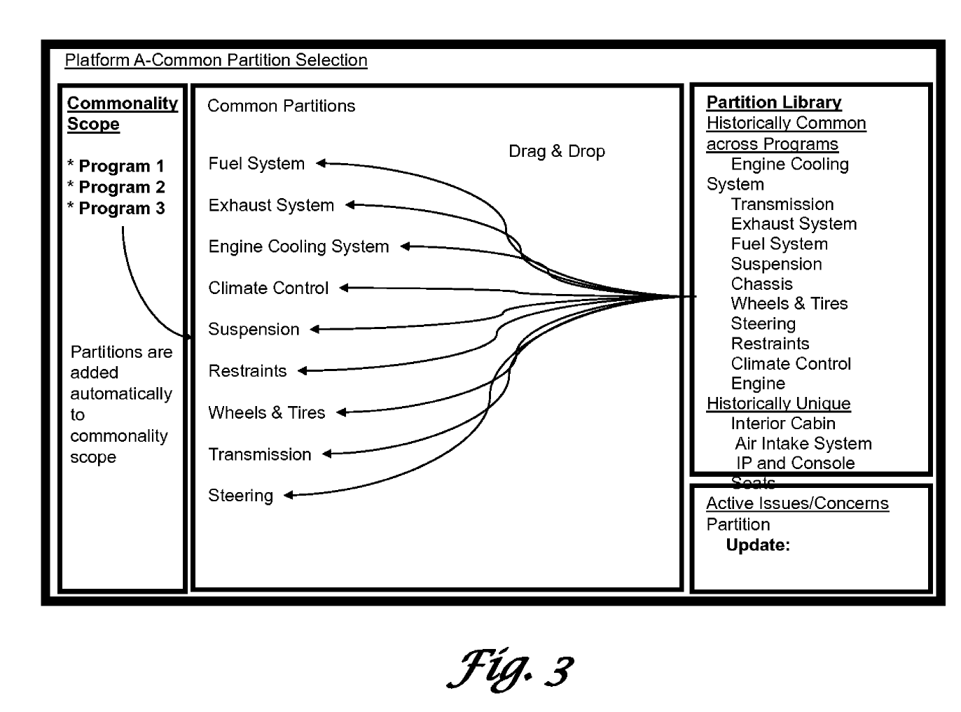

For a platform, define a set of partitions selected form a partition library that will be common for all programs associated with the platform. With an existing library of partitions with preferably a historically common identifier on the individual partitions as well as existing platforms, programs and products, add one or more partitions to the platform and view the current set of platform partitions, as illustrated in FIG. 3.

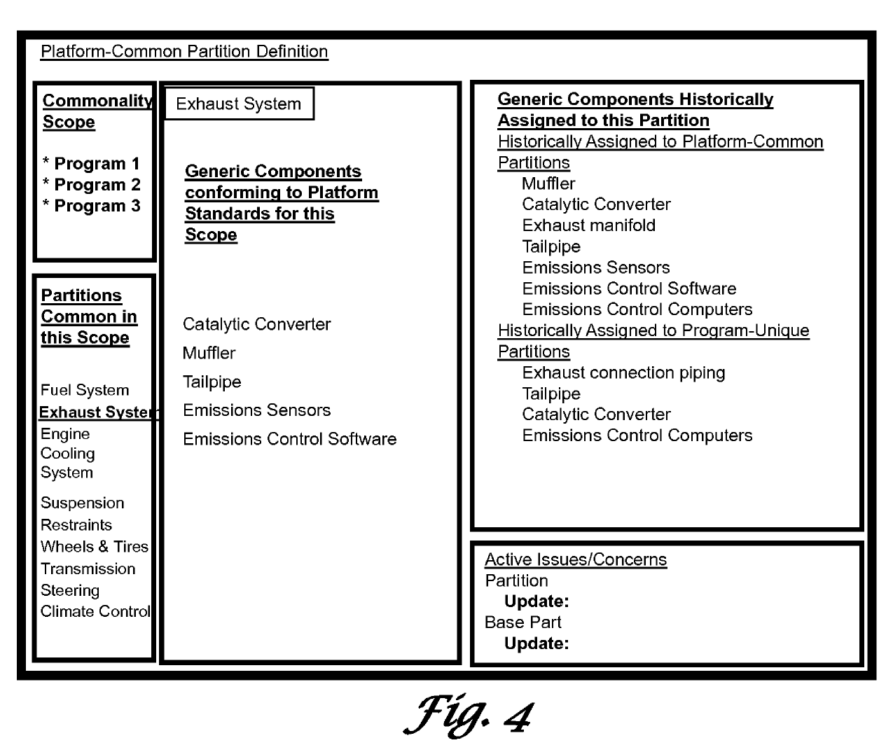

Further, the presently preferred embodiment provides the assignment of generic components to the partition. It is preferable that the components conform to platform standards. With an existing library of partitions with preferably a historically common identifier on the individual components associated with the preferred partition, add one or more generic components to the partition and view the current set of partition's generic components, as illustrated in FIG. 4.

b. Program Architecture

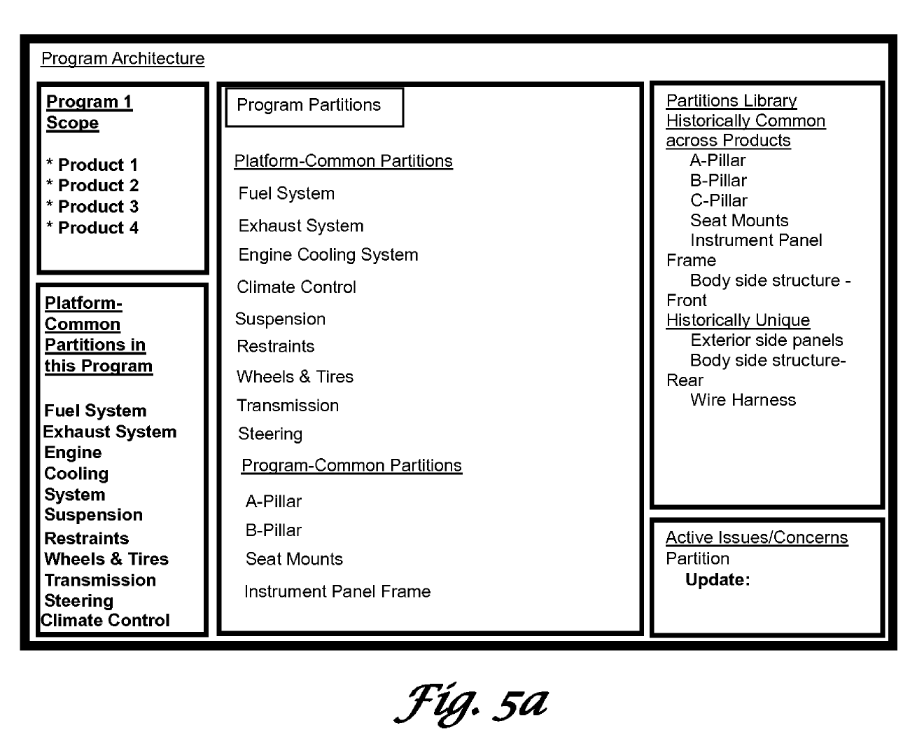

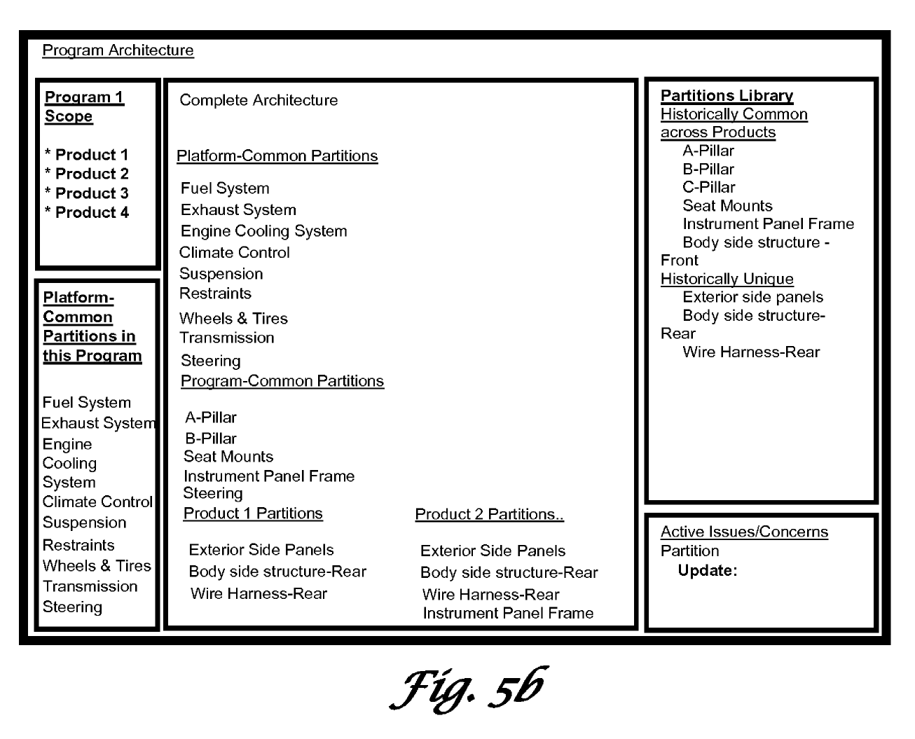

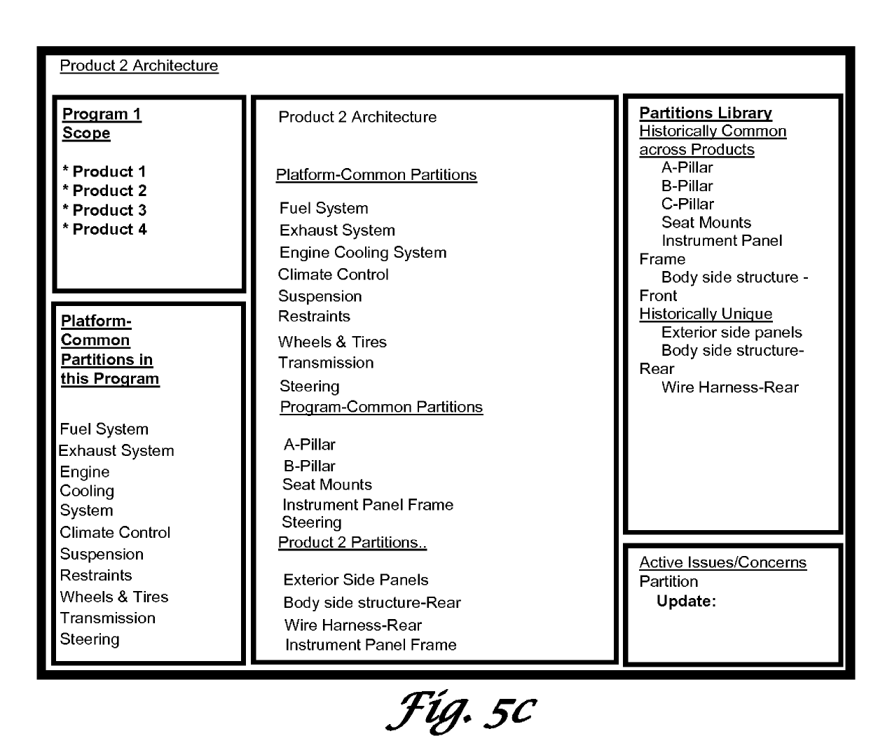

The program physical architecture illustrated in FIGS. 5a-5c preferably defines the products associated with the program, as well as the following partitions sets that describe the program: platform common partitions, program common partitions, and product specific partitions for each product.

c. Overall Process

Early BOM allows users to create high-level product architectures, propose solutions that meet the objectives of those architectures, analyze the solutions from multiple perspectives across alternatives representing different approaches to creating solutions, and evolve the solutions to part usages within the scope of one or more products according to the following prefer steps. First when the user defines a new program, the system responds with entering a program ID into a project table and registering the program name into the configurator as a program scope. Next, when the user opens a program architecture definition tool and/or a partition breakdown authoring tool, the system opens a primary Early BOM perspective, with a tree structure in the center of the graphical user interface (GUI) with a partition library list displayed in a side frame, and list of in-scope products displayed in another frame as illustrated in FIG. 3. Then, when the user determines to add partitions to the program, the system creates applications for the partitions dragged to the center frame and adds the program to the scope of those partition applications. Next when the user adds the partitions to the product, the system records target values for key attributes, plus links to requirements entities, template designs, and available options and option combinations (Variant Expressions). And then the user selects a create solution operation, when the system presents the primary grid UI in the center frame and creates a new header line in the grid to hold the solution definitions so that the user clicks on the solution header to initiate creation of a new solution. Should the user decide to allocate a solution to the partition, the system adds Partition ID to the context/partition field on the solution. Next the user defines alternatives and/or variant strategies for the solution, so that the system then adds one or more alternative codes, and variant expression, to the scope of the Solution. Alternative codes created on the fly by the users in this UI are entered into the feature manager as a type of model within a program scope. Subsequently, the user determines to refine the solution, whereby the system assigns partition IDs to finer-grained partitions, and validates that an application of the assigned partition exists within the stated scope of the solution. Alternatively, the system defines finer-grained solutions without a partition and maintains a link to the source solution.

Aligning the CAD to the solution next involves the system recording the alignment of occurrences of one or more CAD items to the Early BOM Solution. The user then enters attribute values for the solution, resulting in the system recording values as target/plan, predicted, calculated, and measured (actual) where costs may be segmented by material type and weights may be segmented by option, as on a subusage basis. The user then determines to allocate solution content to pre-usages, wherein the system presents a UI to the user to identify a set of pre-usages that are preferably assigned to a single function address, and assign the solution's CAD occurrences to those pre-usages. During this process the system checks that each pre-usage gets occurrences of a single CAD item (or alt reps of a primary CAD item rep). Next the user interleaves carryover content with solutions, wherein the system adds content from the Formal BOM into the Early BOM. Carryover content is organized into function addresses having headers for pre-usages appear under the function address applications in the nested tree grid. Next when the user selects values for consideration in a trade study, the system records attribute value as “active” in the following ways if a solution is flagged “implementation complete” then in the system flags the attributes on its next-lower fine-grained solutions as “active for analysis/calculation/visualization”. This may involve checking whether values for all attributes relevant in a given study have been filled in for those fine-grained solutions. Another way the “active” attribute value is recorded is the user may manually flag an attribute on a solution to be “active” for the scope of a given solution. “Active” flags may skip levels in the partitioning scheme, and in implementation links between coarse and fine-grained solutions And then should the user determine to perform trade studies across alternatives and solutions, then the system will preferably roll up attribute values for a given set of configurations; present the top-level results in a grid with attributes of interest in the rows and alternatives in the columns; and display target, predicted, calculated and measured values for each attribute. UI transitions from the summary grid are transformed to a multi-tree comparison window, to allow the user to drill down the tree for a single attribute. That is, when a single attribute is selected the alternative slices may be expanded as trees and drilled down in the same window as the summary trade study. Allow “active/inactive” selection to take place in this window. Attribute rows can be broken down to allow cost and weight to be decomposed for a given material and/or a given supplier. Attribute rows can be broken down to show cost and weight decomposed by variant strategy within an alternative.

Now when the user determines to compare solutions and the CAD model, the system displays an array of vertical slices containing a solution ID, its partition, its alternative and variant strategy, plus user-selected attributes, and also a 3D visualization window, for each solution to be compared. By selecting a go-forward solution strategy, the system records that a pre-usage has been identified for promotion to program approval. The system can then perform this on a one-by-one basis and also as a large-scale “same-as except” operation across a selected alternative. When the user decides to add a model and option strings to pre-usages, the system adds the model and option strings to pre-usages, and validates these against the configurator. And when the user adds quantity to the pre-usage, the system records quantity for the pre-usage and creates position designators. The system performs quantity mismatch analysis and reports on gaps and/or redundancies in coverage of the CAD model for the pre-usage for the given quantity of interest. Next when the user executes pre-usage validations, the system performs other pre-usage validations based on maturity of the pre-usage. And when the user synchronizes the early BOM and formal BOM, the system updates Early BOM with changes to surrogate pre-Usages (carryover usages that do not change in the new program) when the source of the surrogate is changed in the Formal BOM. The system feeds pre-usages that have reached sufficient maturity and have passed the necessary validations, into the Formal BOM system. And finally when the user selects the part for pre-usage, the system executes part number request to formally issue a part number for inclusion on a pre-usage.

### 4. Conclusion

The presently preferred embodiment may be implemented in digital electronic circuitry, or in computer hardware, firmware, software, or in combinations thereof. An apparatus of the presently preferred embodiment may be implemented in a computer program product tangibly embodied in a machine-readable storage device for execution by a programmable processor; and method steps of the presently preferred embodiment may be performed by a programmable processor executing a program of instructions to perform functions of the presently preferred embodiment by operating on input data and generating output.

The presently preferred embodiment may advantageously be implemented in one or more computer programs that are executable on a programmable system including at least one programmable processor coupled to receive data and instructions from, and to transmit data and instructions to, a data storage system, at least one input device, and at least one output device. The application program may be implemented in a high-level procedural or object-oriented programming language, or in assembly or machine language if desired; and in any case, the language may be a compiled or interpreted language.

Generally, a processor will receive instructions and data from a read-only memory and/or a random access memory. Storage devices suitable for tangibly embodying computer program instructions and data include numerous forms of nonvolatile memory, including by way of example semiconductor memory devices, such as EPROM, EEPROM, and flash memory devices; magnetic disks such as internal hard disks and removable disks; magneto-optical disks; and CD-ROM disks. Any of the foregoing may be supplemented by, or incorporated in, specially-designed ASICs (application2-specific integrated circuits).

A number of embodiments have been described. It will be understood that various modifications may be made without departing from the spirit and scope of the presently preferred embodiment, such as where configurable and/or exploded structures are used in problem domains other than the product structure. For example manufacturing assemblies and manufacturing processes can be both versioned (then configured) and exploded. Therefore, other implementations are within the scope of the following claims that include discoveries through the combination of familiar elements according to known methods.

What is claimed is:

1. A method for defining products, comprising:
creating a platform definition;
reusing said platform definition in a plurality of product configurations; and
delivering said plurality of product configurations to at least one program;
whereby said platform definition is not modified.

2. The method of claim 1, wherein said platform definition is a vehicle platform.

3. The method of claim 1, wherein said at least one program is a business investment cycle.

4. A platform definition, comprising:
a defined list of elements;
a vehicle platform of said defined list of elements;
a plurality of product configurations that can reuse said vehicle platform;
a plurality of programs defined by said plurality of product configurations where said platform definition is not modified.

5. The platform definition of claim 4, wherein said plurality of programs are business investment cycles.

6. A system for platform definition, comprising:
a computer system, wherein said computer system includes a memory, a processor, a user input device, and a display device;
a computer displayed hierarchical list for a product structure; and
wherein a user uses the computer system and the computer system
creates a platform definition; reuses said platform definition in a plurality of product configurations; and delivers said plurality of product configurations to at least one program; whereby said platform definition is not modified.

7. The system of claim 6, wherein said platform definition is a vehicle platform.

8. A data processing system having at least a processor and accessible memory to implement a method for defining a platform, comprising:
means for creating a platform definition;
means for reusing said platform definition in a plurality of product configurations; and
means for delivering said plurality of product configurations to at least one program.
